(19) United States
(12) Patent Application Publication
(10) Pub. No.: US 2025/0280029 A1
(43) Pub. Date: Sep. 4, 2025

(54) METHOD FOR SECURITY INSPECTION BASED ON GENERATIVE ARTIFICIAL INTELLIGENCE AND DIAGNOSTIC DEVICE USING SAME

(71) Applicant: SAMSUNG SDS CO., LTD., Seoul (KR)

(72) Inventors: Seokyong KIM, Seoul (KR); Juhyun LEE, Seoul (KR); Yongseon LEE, Seoul (KR); Hyorim LEE, Seoul (KR); Jinhee KIM, Seoul (KR); Minji KIM, Seoul (KR)

(73) Assignee: SAMSUNG SDS CO., LTD., Seoul (KR)

(21) Appl. No.: 19/063,967

(22) Filed: Feb. 26, 2025

(30) Foreign Application Priority Data
Feb. 29, 2024 (KR) 10-2024-0029887
Mar. 19, 2024 (KR) 10-2024-0038050
Mar. 22, 2024 (KR) 10-2024-0039913
Aug. 12, 2024 (KR) 10-2024-0107710

(51) Int. Cl. H04L 9/40

(52) U.S. Cl. CPC H04L 63/1433; H04L 63/20

(57) ABSTRACT

A processor-implemented method including collecting diagnostic target data by searching for a target server according to a configuration pattern, receiving, from a generative artificial intelligence server, additional diagnostic target data, the generative artificial intelligence server being configured to search the target server for the additional diagnostic target data to merge the additional diagnostic target data with the diagnostic target data, generating a diagnostic script from the diagnostic target data according to an inspection policy, performing an inspection on the target server with the diagnostic script to collect inspection data, and generating a vulnerability analysis result for the target server by using the inspection data.

### CROSS-REFERENCE TO RELATED APPLICATION(S)

This application is based on and claims priority under 35 U.S.C. 119 to Korean Patent Application No. 10-2024-0029887, filed on Feb. 29, 2024, Korean Patent Application No. 10-2024-0038050, filed on Mar. 19, 2024, Korean Patent Application No. 10-2024-0039913, filed on Mar. 22, 2024, and Korean Patent Application No. 10-2024-0107710, filed on Aug. 12, 2024, in the Korean Intellectual Property Office, the disclosures of which are herein incorporated by reference in its entirety.

### BACKGROUND

### 1. Field of the invention

The disclosure relates to a security inspection method based on generative artificial intelligence that performs a security inspection on a target server based on generative artificial intelligence, and a diagnostic device using the same.

### 2. Description of the Prior Art

With the development of the information industry and technology, various types of network systems suitable for different user environments are being developed. In other words, modern society is developing to provide various services by connecting various devices and systems that are closely related to human life, such as home network devices, network robots, and the like.

In general, in the case of the internal network or service network of a company, security equipment or security control systems may be equipped to respond to cyberattacks. However, threats such as web hacking, web shell, DDOS, malware, APT, insider attacks, etc. have been continuously increasing, and continuous security inspections are required to maintain network security.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including collecting diagnostic target data by searching for a target server according to a configuration pattern, receiving, from a generative artificial intelligence server, additional diagnostic target data, the generative artificial intelligence server being configured to search the target server for the additional diagnostic target data to merge the additional diagnostic target data with the diagnostic target data, generating a diagnostic script from the diagnostic target data according to an inspection policy, performing an inspection on the target server with the diagnostic script to collect inspection data, and generating a vulnerability analysis result for the target server by using the inspection data.

The collecting of the diagnostic target data may include searching for web pages included in the target server by using a hyperlink after logging in to the target server and collecting uniform resource identifiers (URIs) of the searched web pages and parameters corresponding to the URIs as the diagnostic target data.

The merging of the diagnostic target data may include receiving, from the generative artificial intelligence server, the additional diagnostic target data for a missing web page or parameter when searching for the target server.

The merging of the diagnostic target data may include receiving, from the generative artificial intelligence server, the additional diagnostic target data for the missing web page when a URI of the missing webpage and a prompt including a header area or body area responsive to a request message for the webpage being input to the generative artificial intelligence server.

The generative artificial intelligence server may be configured to extract each parameter corresponding to the URI according to a HTTP protocol-based POST method or a GET method used in the request message and to generate the additional diagnostic target data.

The collecting of the inspection data may include performing the inspection on the target server based one or more of passive inspection, active inspection, and singular inspection according to the inspection policy.

The collecting of the inspection data may include updating the inspection policy upon receiving an additional inspection policy for the target server from the generative artificial intelligence server.

The collecting of the inspection data may include receiving, from the generative artificial intelligence server, an additional inspection policy for performing an inspection on missing diagnostic target data or an attack pattern when inspecting the target server.

The collecting of the inspection data may include generating an additional diagnostic script from the diagnostic target data according to the updated inspection policy, performing inspection on the target server with the additional diagnostic script to collect additional inspection data, and merging the additional inspection data with the inspection data.

In a general aspect, here is provided a non-transitory computer-readable storage medium storing instructions that, when executed by a processor, cause the processor to perform the method.

In a general aspect, here is provided an electronic device including one or more processors configured to execute instructions and a memory storing the instructions, and an execution of the instructions configures the processors to collect diagnostic target data by searching for a target server according to a configuration pattern, receive, from a generative artificial intelligence server, additional diagnostic target data, the generative artificial intelligence server being configured to search the target server for the additional diagnostic target data, and merging the additional diagnostic target data with the diagnostic target data, generate a diagnostic script from the diagnostic target data according to an inspection policy, perform an inspection on the target server with the diagnostic script to collect inspection data, and generate a vulnerability analysis result for the target server by using the inspection data.

The collecting of the diagnostic target data may include searching for web pages included in the target server by using a hyperlink after logging in to the target server, and collecting uniform resource identifiers (URIs) of the searched web pages and parameters corresponding to the URIs as the diagnostic target data.

The merging of the diagnostic target data may include receiving, from the generative artificial intelligence server, the additional diagnostic target data for a missing web page when searching for the target server according to the configuration pattern.

The merging of the diagnostic target data may include receiving, from the generative artificial intelligence server, the additional diagnostic target data for the missing web page when a URI of the missing webpage and a prompt including a header area or body area responsive to a request message for the webpage being received by the generative artificial intelligence server.

The generative artificial intelligence server may be configured to extract each parameter corresponding to the URI according to a HTTP protocol-based POST method or a GET method used in the request message to generate the additional diagnostic target data.

The collecting of the inspection data may include performing the inspection on the target server based on one or more of passive inspection, active inspection, and singular inspection according to the inspection policy.

The collecting of the inspection data may include updating the inspection policy upon receiving an additional inspection policy for the target server from the generative artificial intelligence server.

The collecting of the inspection data may include receiving, from the generative artificial intelligence server, an additional inspection policy for performing an inspection on missing diagnostic target data or an attack pattern when inspecting the target server.

The collecting of the inspection data may include generating an additional diagnostic script from the diagnostic target data according to the updated inspection policy, performing inspection on the target server with the additional diagnostic script to collect additional inspection data, and merging the additional inspection data with the inspection data.

### BRIEF DESCRIPTION OF THE DRAWINGS

FIG. 1 is a schematic diagram illustrating a security inspection system according to an embodiment of the disclosure;

FIG. 2 is a block diagram illustrating a diagnostic device according to an embodiment of the disclosure;

FIG. 3 is a schematic diagram illustrating an operation of a diagnostic device according to an embodiment of the disclosure;

FIG. 4A and FIG. 4B are exemplary diagrams illustrating parameter extraction according to the GET method and the POST method in an embodiment of the disclosure;

FIG. 5 is a flowchart illustrating an operation of a diagnostic device according to an embodiment of the disclosure;

FIG. 6 is a block diagram illustrating a computing device according to an embodiment of the disclosure;

FIG. 7 is a flowchart illustrating a security inspection method according to an embodiment of the disclosure;

FIG. 8 is a schematic diagram illustrating a security inspection system according to another embodiment of the disclosure;

FIG. 9 is a flowchart illustrating a security tool inspection according to an embodiment of the disclosure;

FIG. 10 is a flowchart illustrating a regression test according to an embodiment of the disclosure; and

FIG. 11 is a flowchart illustrating simulated hacking according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

As used in connection with various example embodiments of the disclosure, any use of the terms “module” or “unit” means hardware and/or processing hardware configured to implement processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such executable instructions may include components such as program components, object-oriented code or program components, class components, and may include processor task components, processes, functions, attributes, procedures, subroutines, segments of the code or program. Executable instructions may further include programs, drivers, firmware, microcode, circuits, data, database, data structures, tables, arrays, and variables. In another non-limiting example, such executable instructions may be executed by one or more central processing units (CPUs) of an electronic device or secure multimedia card.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The disclosure is to provide a security inspection method based on generative artificial intelligence, which may interactively add missing web pages or parameters during search by using generative artificial intelligence, and a diagnostic device using the same.

The disclosure is to provide a security inspection method based on generative artificial intelligence, which may interactively add missing attack patterns or the latest inspection patterns during inspection by using generative artificial intelligence, and a diagnostic device using the same.

The disclosure is to provide a security inspection method based on generative artificial intelligence, which may automate a security inspection using a security tool and automate simulated hacking, and a diagnostic device using the same.

According to a security inspection method based on generative artificial intelligence and a diagnostic device using the same according to an embodiment of the disclosure, by using generative artificial intelligence, web pages or parameters that are missing during search may be added interactively, so that the search performance for web pages within the target server may be improved. In addition, attack patterns that are missing during inspection or the latest inspection patterns may be added and reflected, so that the performance of automatic inspection on the target server may be improved.

According to a security inspection method based on generative artificial intelligence and a diagnostic device using the same according to an embodiment of the disclosure, by utilizing generative artificial intelligence, simulated hacking may be performed with a minimum amount of information, specialized for each target server, and it is possible to automatically generate and provide a standardized correction code even when performing an inspection using a security tool. That is, since security inspection and vulnerability improvement may be performed without a security manager and a system manager for correcting the source code, the effects of increased productivity and reduced costs such as manpower may be obtained.

However, the effects that may be achieved by the security inspection method based on generative artificial intelligence and the diagnostic device using the same according to embodiments of the disclosure are not limited to those mentioned above, and other effects that are not mentioned will be clearly understood by a person having ordinary skill in the art to which the disclosure belongs from the description below.

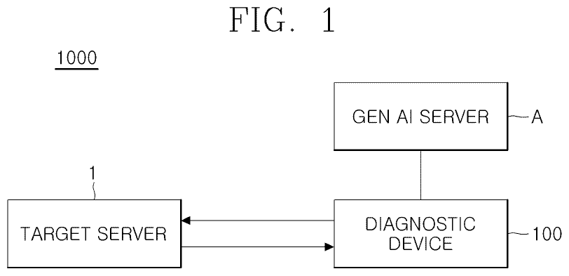

FIG. 1 is a schematic diagram illustrating a security inspection system according to an embodiment of the disclosure.

Referring to FIG. 1, a security inspection system 1000 according to an embodiment of the disclosure may include a target server 1, a Gen AI server A, and a diagnostic device 100.

Hereinafter, the security inspection system 1000 according to an embodiment of the disclosure will be described with reference to FIG. 1.

The target server 1 may be a World Wide Web (WEB) server or a Web Application Server (WAS) server that provides various types of online services, and may provide HyperText Markup Language (HTML)-based pages, etc. in response to requests from terminal devices (not shown) accessing the target server 1. As illustrated in FIG. 1, the target server 1 may be implemented as a separate physical configuration, but depending on the embodiment, it may also be implemented as a virtual machine included in a cloud server, etc.

The diagnostic device 100 may diagnose the target server 1 and analyze vulnerabilities in web pages, web applications, and the like provided by the target server 1. That is, the diagnostic device 100 may perform an inspection on vulnerabilities that allow a user accessing the target server 1 to perform operations exceeding the authorized authority or to view, modify, or leak information exceeding the authorized scope due to a defect in the hardware or software of the target server 1 or a design flaw.

Specifically, the diagnostic device 100 may perform a diagnosis on various types of vulnerabilities, such as structured query language (SQL) inspection, cross site scripting (XSS), server side request forgery (SSRF), and the like, on the target server 1. That is, the diagnostic device 100 may diagnose vulnerabilities of the target server 1 by performing a mock attack on the target server 1.

In the past, when performing a security inspection on the target server 1 by using the diagnostic device 100, the security inspection was performed automatically according to a preconfigured pattern. That is, the security inspection was performed by searching for a web page based on a hyperlink included in the target server 1, modulating the parameters extracted from the web page into attack codes and transmitting the same, and then analyzing whether there were any vulnerable parts in the response message received from the target server 1.

However, if there is a web page that is not connected to a hyperlink in the target server 1, the search for the web page may be missing, and the security inspection may not be performed on the corresponding uniform resource identifier (URI). In addition, after searching for the webpage for the target server 1, the parameters of the webpage are recognized and a security inspection is performed depending on the GET or POST method of the HyperText Transfer Protocol (HTTP), but there may be a case of missing recognition of some parameters. That is, a problem such as no security inspection on the missing parameters may occur. In addition, if a security inspection is performed according to a preconfigured pattern, the security inspection is performed for a limited number of types of vulnerabilities, so it is difficult to perform a security inspection reflecting the latest trends, and there are limitations such as the missing of inspections for vulnerabilities that are expected to be necessary.

Meanwhile, according to the security inspection system 1000 according to an embodiment of the disclosure, it is possible to supplement missing web pages or parameters, etc. by linking the diagnostic device 100 and the Gen AI server A, and it is possible to implement a security inspection by reflecting in real time a security inspection according to a new pattern or a vulnerability diagnosis that requires additional inspection.

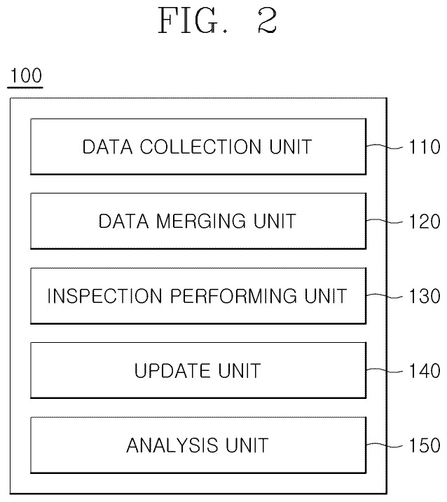

Here, the Gen AI server A may include a generative AI model that performs various functions based on generative artificial intelligence. That is, the operator of the security inspection system 1000 may use the generative AI model provided by the Gen AI server A to interactively inform the diagnostic server 100 of missing web pages or parameters, or provide a vulnerability diagnostic method to be added. In this case, the Gen AI server A may request the diagnostic server 100 to perform an inspection thereon by providing missing web pages or parameters, and may update the inspection policy of the diagnostic device 100 to reflect the input vulnerability diagnostic method and the inspect the same. Through this, the web page and parameter search performance of the diagnostic server 100 may be improved, and the automatic inspection performance may be improved to reflect the latest inspection pattern. Hereinafter, the diagnostic server 100 according to an embodiment of the disclosure will be described with reference to FIG. 2.

FIG. 2 is a block diagram illustrating a diagnostic device according to an embodiment of the disclosure.

Referring to FIG. 2, the diagnostic device 100 according to an embodiment of the disclosure may include a data collection unit 110, a data merging unit 120, an inspection performing unit 130, an update unit 140, and an analysis unit 150.

The data collection unit 110 may search for the target server 1 according to the configuration pattern and collect the diagnostic target data. Here, the data collection unit 110 may first receive basic information on the target server 1. That is, the operator may provide basic information on the target server 1 in advance so that web page search and vulnerability inspection may be performed based on the basic information received.

Here, the basic information may include basic information including environment information and access information for accessing the target server 1, and authentication information including login information for logging in to the target server 1. Specifically, the environment information may include information on the type or version of the operating system (OS) or database management system (DBMS) applied to the target server 1, and the access information may include a uniform resource locator (URL) address for accessing the target server 1. In addition, the login information may include account information such as an ID and password used for form authentication for logging in to the target server 1, or temporary authentication values such as a session or cookie used for header authentication or client certificate authentication.

In addition, the basic information may further include information on HTTP Archive files (HAR), Comma-Separated Value (CSV) API, Representational State Transfer (REST) API, Web Application Description Language (WADL), Web Service Definition Language (WSDL), open API, and the like of the target server 1.

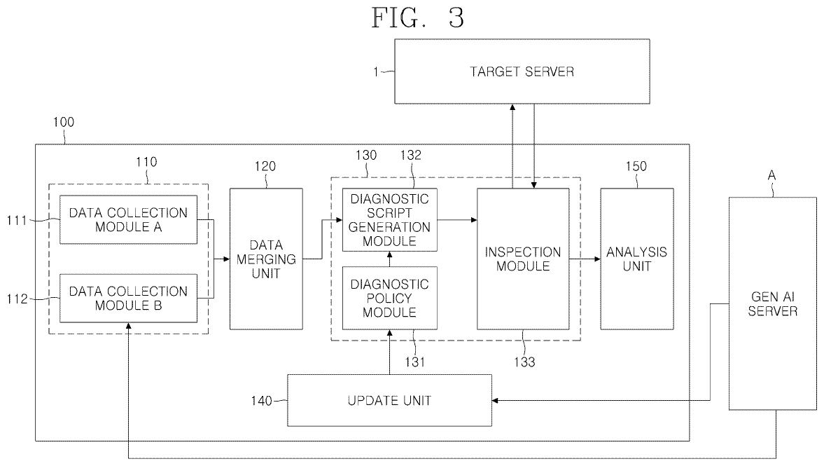

Thereafter, the data collection unit 110 may log in to the target server 1 by using the basic information, and search for web pages included in the target server 1 by using hyperlinks of each object disclosed in the web page that appears after logging in. Here, the data collection unit 110 may collect the URIs of the searched web pages and the parameters corresponding to the URIs as the diagnostic target data. Referring to FIG. 3, the data collection unit 110 may include a data collection module A 111 and a data collection module B 112.

The data collection module A 111 primarily collects diagnostic target data, and may search for web pages based on the hyperlink to collect diagnostic target data from each web page after logging in to the target server 1.

The data collection module B 112 may collect additional diagnostic target data for web pages or parameters missing from the data collection module A 111. That is, the operator may input a prompt including a URI for the missing webpage into the Gen AI server A, and the Gen AI server A may extract and provide information on the missing webpage and parameters based on the prompt. In this case, data collection module B 122 may receive and store additional diagnostic target data for the missing web page and parameters from the Gen AI server A.

According to an embodiment, a list of web pages and parameters of the target server 1 collected by the data collection module A 111 may be provided to the operator, and the operator may identify the list to determine whether a missing web page exists among the web pages included in the target server 1. When a missing webpage or the like exists, the operator may input a prompt to the Gen AI server A to request additional diagnostic target data for the missing webpages to be collected.

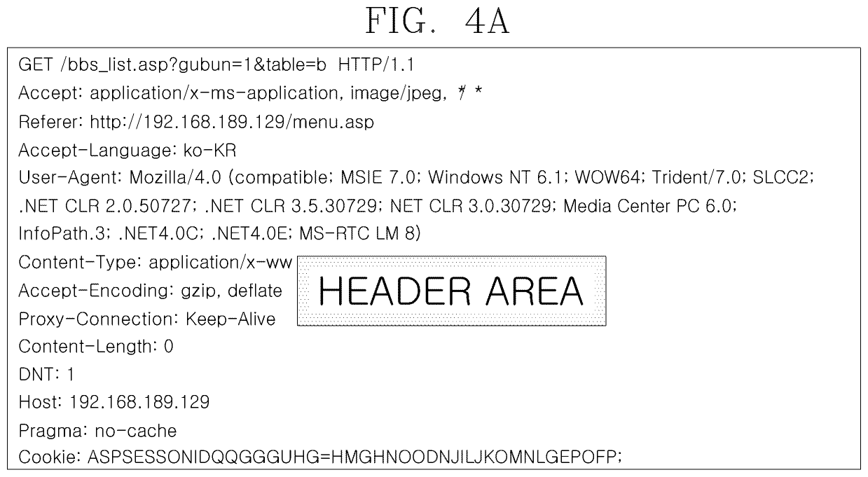

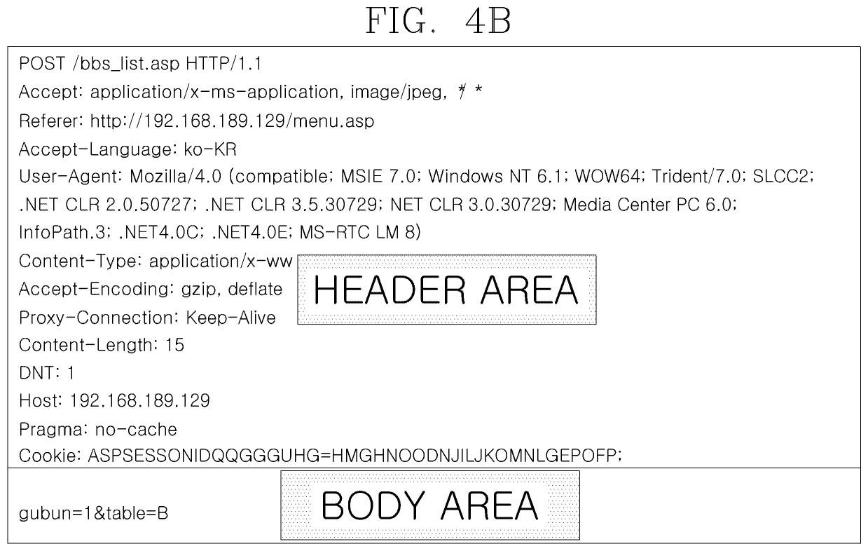

Specifically, the operator may directly input the header area or body area according to the HTTP protocol of the missing web page interactively in the prompt, and request to extract the corresponding parameter in the GET or POST method. Here, in the case of the GET method, as illustrated in FIG. 4(a), the header area may be input to extract the corresponding parameter, and in the case of the POST method, as illustrated in FIG. 4(b), both the header and the body areas may be input to extract the corresponding parameter. In addition, depending on the embodiment, it is also possible to extract the parameter by inputting the GET or POST parameter extraction method by using the prompt and then inquiring about the parameters of each web page.

That is, the Gen AI server A may generate additional extract each parameter corresponding to the URI of the corresponding webpage according to the POST method or GET method used in the request message of the corresponding webpage, and generate additional diagnostic target data. Thereafter, the data collection module B 112 may collect additional diagnostic target data for the target server 1 from the Gen AI server A.

The data merging unit 120 may merge the diagnostic target data with the additional diagnostic target data. That is, the data merging unit 120 may receive the additional diagnostic target data collected by searching for the target server 1 from the Gen AI server A, and may merge the received additional diagnostic target data with the previously collected diagnostic target data. Here, the additional diagnostic target data is collected for the missing webpage or parameter when searching for the target server 10, and may be generated by the Gen AI server A.

As illustrated in FIG. 3, the data merging unit 120 may receive diagnostic target data from data collection module A 111, receive additional diagnostic target data from data collection module B 112, and merge each diagnostic target data with the additional diagnostic target data to generate standardized data. Thereafter, the merged diagnostic target data may be stored in a storage unit (not shown).

The inspection performing unit 130 may generate a diagnostic script from the diagnostic target data according to the inspection policy, and perform an inspection on the target server 1 with the diagnostic script, thereby collecting inspection data from the target server 1. Referring to FIG. 3, the inspection performing unit 130 may include a diagnostic policy module 131, a diagnostic script generation module 132, and an inspection module 133.

The diagnostic policy module 131 may determine the inspection policy to be applied to the target server 1. That is, the diagnostic policy module 131 may determine the inspection policy for inspecting the target server 1 based on the collected diagnostic target data and basic information, and may be implemented so that unnecessary inspections are not performed. For example, if the DBMS of the target server 1 is Mysql, the inspection may be performed according to the inspection policy that defines the SQL injection attack pattern by using only the special characters corresponding to “—” recognized as comments in the Mysql.

According to an embodiment, a preconfigured embedded inspection policy may be stored, and the diagnostic policy module 131 may perform an inspection according to the embedded inspection policy. Thereafter, the inspection policy may be updated by the update unit 140, and in this case, the diagnostic policy module 131 may be configured to perform an inspection according to the updated inspection policy.

The diagnostic script generation module 132 may generate a diagnostic script by using the URI and parameters of each web page according to the inspection policy. For example, if it is determined to perform an inspection on SQL injection as the inspection policy, the diagnostic script generation module 132 may generate a login bypass script (‘or 1=1—) to be input instead in the parameters corresponding to the ID and password in the login page of the target server 1.

The inspection module 133 may configure the inspection type to be a passive inspection, an active inspection, a singular inspection, and the like according to the inspection policy, and may perform an inspection on the target server 1 accordingly.

The passive inspection may be to monitor network traffic on the target server 1 or to identify vulnerabilities by analyzing logs, etc.

The active inspection is to identify vulnerabilities by performing a direct test on the target server 1, and may analyze the vulnerabilities from the response message of the target server 1 after modulating and inputting parameters in the request message into an attack pattern. That is, in the case of the active inspection, the parameters included in each web page in the target server 1 may be modulated into a diagnostic script to transmit a request message to the target server 1, and inspection data including a response message corresponding to the corresponding request message may be collected. For example, the inspection may be performed by inputting a diagnostic script (‘or 1=1—) into the “username” field of the URI corresponding to the login page of the target server 1.

The singular inspection may be focused on specific vulnerabilities or specific servers, and depending on the embodiment, may be to perform only one inspection on each of the plurality of target servers 1 and not to perform inspections on all web pages in the target server 1.

When receiving an additional inspection policy for the target server 1 from the Gen AI server A, the update unit 140 may update the inspection policy. That is, the update unit 140 may receive an additional inspection policy from the Gen AI server A to perform an inspection on missing diagnostic target data or attack patterns during the inspection on the target server 1. The operator may identify the inspection progress list performed by the inspection performing unit 130, and if there are missing parameters or attack patterns, the operator may input a prompt to the Gen AI server A to request additional inspection. For example, the operator may interactively input the URL, parameter, and attack method of the web page wishing to attack the prompt.

In this case, the Gen AI server A may generate an additional inspection policy corresponding to the prompt and transmit the same to the update unit 140. For example, the operator may input a prompt such as “The login page is a login.php file, and tell me the attack pattern when using oracle DBMS for the ID parameter here”, and the Gen AI server A may generate an additional inspection policy including the corresponding attack pattern and provide the same to the update unit 140.

Thereafter, the update unit 140 may update the additional inspection policy to the diagnostic policy module 131 to perform an inspection according to the updated additional inspection policy. That is, the diagnostic script generation module 132 may generate an additional diagnostic script from the diagnostic target data according to the additional inspection policy, and the inspection module 133 may generate additional inspection data by performing an inspection on the target server 1 by using the additional diagnostic script. Here, the additional inspection data may be merged with the inspection data generated according to the embedded inspection policy. That is, the analysis unit 150 may further consider the additional inspection data to perform vulnerability analysis on the corresponding target server 1.

Meanwhile, the update unit 140 may provide a list of additional inspection policies to the operator, and update only the additional inspection policy selected by the operator among a plurality of additional inspection policies. In addition, depending on the embodiment, it is also possible to filter additional inspection policies to be updated among a plurality of additional inspection policies based on a preconfigured rule.

The analysis unit 150 may generate a vulnerability analysis result for the target server 1 by using the inspection data. That is, the analysis unit 150 may generate a vulnerability analysis result including both inspection data according to the embedded inspection policy and an additional inspection policy according to the updated inspection policy, and may list and provide the found vulnerabilities and action guides for each vulnerability to the operator. In addition, the analysis unit 150 may provide audit information along with the vulnerability analysis result so that it may determine whether the generated vulnerability is true positive or false positive.

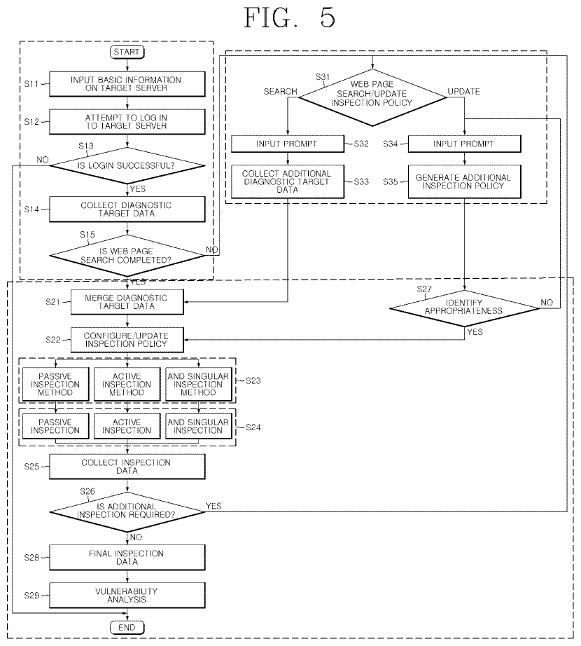

FIG. 5 is a flowchart illustrating an operation of a diagnostic device 100 according to an embodiment of the disclosure. Referring to FIG. 5, in order to perform a security inspection on the target server 1, the diagnostic device 100 may first receive basic information on the target server 1 (S11). Thereafter, the diagnostic device 100 may attempt to log in to the target server 1 (S12), and if the login is successful (S13), the diagnostic device 100 may search for the target server 1 and collect diagnostic target data (S14). Here, the diagnostic device 100 may automatically attempt to log in based on the login information included in the basic information, and if the login fails, the diagnostic device 100 may repeatedly attempt to log in (S12). However, if the login fails more than the configured number of times (e.g., 5 times), the login is ultimately considered to have failed (S13), and the vulnerability analysis on the target server 1 cannot be performed and ends.

The diagnostic device 100 may collect diagnostic target data by searching for web pages included in the target server 1 based on the hyperlink in the target server 1 according to a preconfigured pattern. For example, web pages may be searched along hyperlinks of each menu included in the web page, and search may be performed sequentially up to submenus included in each menu. Thereafter, when the web page search is completed (S15), an automatic inspection of the target server 1 may be performed (S21 to S29). However, when the web page search is not completed (S15), additional diagnostic target data may be provided from the Gen AI server A. Here, the operator of the diagnostic device 100 may determine whether the webpage search is complete. For example, the diagnostic device 100 may provide the operator with a list of searched webpages and parameters, and the operator may determine whether the webpage search for the target server 1 is completed based on the list. Here, if it is determined that the web page search is not completed, the operator may request the collection of additional diagnostic target data for the missing webpages and parameters through the Gen AI server A.

Specifically, if the web page search is not completed (S31), the operator may input a natural language-based prompt for web page search (S32), and the Gen AI server A may generate additional diagnostic target data such as parameters for the missing web page based on the prompt and provide the same to the diagnostic device 100. Here, the URI of the web page, the header area of the HTTP prompt, and the body area may be input in the prompt, and based on this, the Gen AI server A may extract the parameters of the corresponding web page according to the GET method or the POST method.

If the web page search is completed (S15), the diagnostic device 100 may merge the collected diagnostic target data with additional diagnostic target data (S21), and configure an inspection policy for performing a security inspection on the target server 1. Here, the diagnostic device 100 may be configured to perform an inspection according to a preconfigured embedded inspection policy, and then may be configured to perform an inspection according to an additional inspection policy when the inspection policy is updated.

Here, the inspection type may include a passive inspection method, an active inspection method, a singular inspection method, etc., and a diagnostic script may be generated for each inspection type (S23). Thereafter, the passive inspection, the active inspection, the singular inspection may be performed by using each diagnostic script (S24), and then the performed inspection data may be collected (S25).

Thereafter, it is identified whether additional inspection is required (S26), and if additional inspection is required, an additional inspection policy for additional inspection may be generated through the Gen AI server A. That is, the operator may receive an inspection progress list, etc. from the diagnostic device 100, and if there are missing parameters or attack patterns, etc. from the inspection progress list, the operator may input a prompt to the Gen AI server A to update the inspection policy so that an additional inspection on the missing parameters or attack patterns, etc. may be performed.

Specifically, when the operator wants to update the inspection policy (S31), the URL, parameters, and attack methods of the web page wishing to be attacked may be interactively input into the prompt of the Gen AI server A (S34), and the Gen AI server A may generate an additional inspection policy in response to the input prompt (S35).

Thereafter, the diagnostic device 100 may identify the appropriateness of the generated additional inspection policy (S27). That is, the diagnostic device 100 may provide the operator with a list of generated additional inspection policies so that the operator may determine the appropriateness of the additional inspection policies. In this case, the diagnostic device 100 may update only the additional inspection policy selected by the operator from among a plurality of additional inspection policies. In addition, depending on the embodiment, it is possible to determine an additional inspection policy to be updated by filtering inappropriate additional inspection policies based on a preconfigured rule.

Here, the diagnostic device 100 may update the additional inspection policy (S22) and perform inspection according to the updated additional inspection policy. That is, according to the additional inspection policy, an additional diagnostic script may be generated from the diagnostic target data (S23), and an inspection may be performed on the target server 1 by using the additional diagnostic script to generate additional inspection data (S24). Here, the additional inspection data may be merged with the inspection data generated according to the embedded inspection policy (S25). That is, it is possible to perform a vulnerability analysis on the target server 1 by further considering the additional inspection data.

If it is determined that no additional inspection is required (S27), final inspection data in which the inspection data and the additional inspection data are merged may be generated (S28), and based on this, the vulnerability analysis on the target server 1 may be performed (S29). That is, the diagnostic device 100 may list and provide the vulnerability of the target server 1 and the action guide for each vulnerability from the final inspection data to the operator. In addition, audit information may be provided together so that it is identified whether the vulnerability is true positive or false positive.

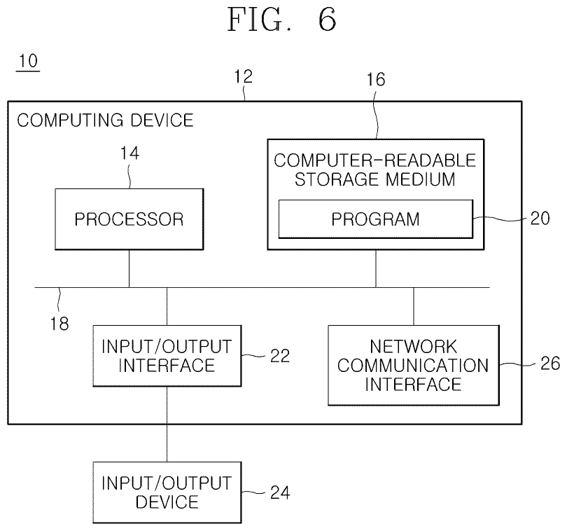

FIG. 6 is a block diagram illustrating a computing environment 10 suitable for use in exemplary embodiments. In the illustrated embodiment, each component may have different functions and capabilities other than those described below, and may include additional components other than those described below.

The illustrated computing environment 10 includes a computing device 12. In an embodiment, the computing device 12 may be the diagnostic devices 100 and 200 according to an embodiment of the disclosure.

The computing device 12 includes at least one processor 14, a computer-readable storage medium 16, and a communication bus 18. The processor 14 may cause the computing device 12 to operate according to the exemplary embodiment mentioned above. For example, the processor 14 may execute one or more programs stored in the computer-readable storage medium 16. The one or more programs may include one or more computer-executable instructions, and the computer-executable instructions may be configured to cause the computing device 12 to perform operations according to exemplary embodiments when executed by the processor 14.

The computer-readable storage medium 16 is configured to store computer executable instructions or program codes, program data, and/or other suitable forms of information. The program 20 stored in the computer-readable storage medium 16 includes a set of instructions executable by the processor 14. In an embodiment, the computer-readable storage medium 16 may a memory (volatile memory such as random access memory, nonvolatile memory, or a suitable combination thereof), one or more magnetic disk storage devices, optical disk storage devices, flash memory devices, other types of storage media accessed by the computing device 12 and capable of storing desired information, or a suitable combination thereof.

The communication bus 18 interconnects other various components of the computing device 12, including the processor 14 and the computer-readable storage medium 16.

The computing device 12 may also include one or more input/output interfaces 22 and one or more network communication interfaces 26 that provide interfaces for one or more input/output devices 24. The input/output interface 22 and the network communication interface 26 are connected to the communication bus 18. The input/output device 24 may be connected to other components of the computing device 12 through the input/output interface 22. The exemplary input/output device 24 may include an input device such as a pointing device (such as a mouse or a track pad), a keyboard, a touch input device (such as a touch pad or a touch screen), a voice or sound input device, various types of sensor devices, and/or a photographing device, and/or may include an output device such as a display device, a printer, a speaker and/or a network card. The exemplary input/output device 24 may be included inside the computing device 12 as a component constituting the computing device 12, or may be connected to the computing device 12 as a separate device distinct from the computing device 12.

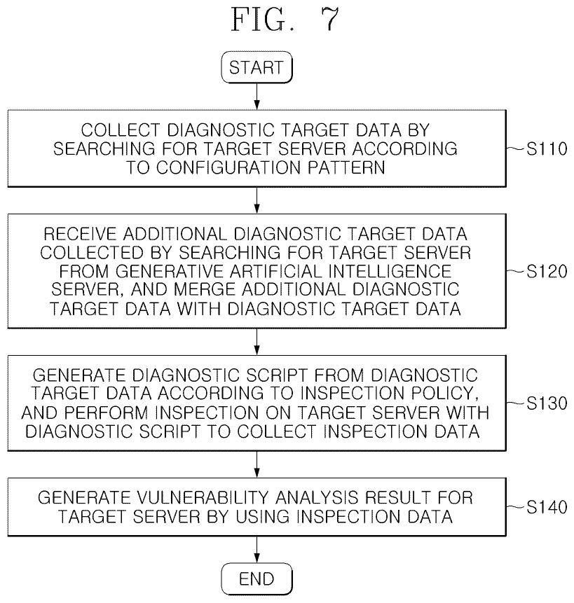

FIG. 7 is a flowchart illustrating a security inspection method according to an embodiment of the disclosure. Each step in FIG. 7 may be performed by a diagnostic device according to an embodiment of the disclosure.

Referring to FIG. 7, the diagnostic device may search for a target server according to a configuration pattern, and collect diagnostic target data (S110). Here, the diagnostic device may first receive basic information on the target server. That is, the operator may provide basic information on the target server in advance to perform web page search and vulnerability inspection based on the input basic information. Thereafter, after logging in to the target server, the diagnostic device may search for web pages included in the target server by using a hyperlink, and collect URI of the searched web pages and parameters corresponding to the URI as diagnostic target data.

Thereafter, the diagnostic device may receive the additional diagnostic target data collected by searching for the target server from the generative artificial intelligence server, and may merge the additional diagnostic target data with the diagnostic target data (S120). That is, in the process of searching for the target server by the diagnostic device, some web pages or parameters may be missing. Accordingly, the operator may input a prompt including the URI for the missing web page into the generative artificial intelligence server, and the generative artificial intelligence server may extract information on missing web pages and parameters based on the corresponding prompt and provide the same to the diagnostic device.

Specifically, the operator may input a URI for the missing web page and a prompt including a header area or a body area in a request message for the web page to the generative artificial intelligence server. In this case, the generative artificial intelligence server may extract each parameter corresponding to the URI according to the POST method or GET method based on the HTTP protocol used in the request message, and generate additional diagnostic target data. In this case, the generative artificial intelligence server may generate additional diagnostic target data for the missing web page, and the diagnostic device may receive the additional diagnostic target data from the generative artificial intelligence server. The diagnostic device may merge the received additional diagnostic target data with the diagnostic target data.

Thereafter, the diagnostic device may generate a diagnostic script from the diagnostic target data according to the inspection policy, perform an inspection on the target server with the diagnostic script to collect inspection data (S130). Here, the diagnostic device may perform an inspection on the target server in a manner such as a passive inspection, an active inspection, a singular inspection, etc. according to the inspection policy, and collect inspection data generated as a result of the inspection.

In addition, depending on the embodiment, the diagnostic device may receive an additional inspection policy for the target server from the generative artificial intelligence server, and may update the inspection policy with the received additional inspection policy. That is, the operator may identify the inspection progress list performed by the diagnostic device, and if there are missing parameters or attack patterns, a prompt may be input to the generative artificial intelligence server to request the generation of an additional inspection policy. Therefore, when inspecting the target server, the diagnostic device may receive an additional inspection policy from the generative artificial intelligence server for performing an inspection on missing diagnostic target data or attack patterns.

Thereafter, the diagnostic device may generate an additional diagnostic script from the diagnostic target data according to the updated inspection policy, and perform inspection on the target server with the additional diagnostic script to collect additional inspection data. Here, the additional inspection data may be merged with the inspection data.

When the inspection on the target server is completed, the diagnostic device may generate a vulnerability analysis result for the target server by using the collected inspection data (S140). That is, the diagnostic device may generate the vulnerability analysis result including both inspection data according to the embedded inspection policy and additional inspection policy according to the updated inspection policy, and list the discovered vulnerabilities and the vulnerability-specific action guide and provide them to the operator. In addition, the diagnostic device may provide audit information along with the vulnerability analysis result to determine whether the generated vulnerability is true positive or false positive.

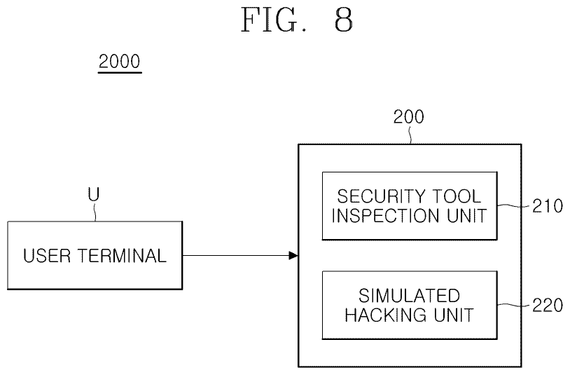

FIG. 8 is a schematic diagram illustrating a security inspection system 2000 according to another embodiment of the disclosure. Referring to FIG. 8, a security inspection system according to an embodiment of the disclosure may include a user terminal U and a diagnostic device 200.

The user terminal U may be connected to the diagnostic device 200 by using a wired or wireless network, and the operator of the security inspection system 2000 may control the diagnostic device 200 to perform a security inspection, etc. on a target server (not shown) by using the user terminal U.

The user terminal U may be equipped with a communication module for transmitting and receiving information, a memory for storing programs and protocols, a processor for executing various programs and performing calculations and controls, etc. In addition, depending on the embodiment, the user terminal U may further include devices such as a camera, a microphone, a speaker, and a display.

The user terminal U may be a mobile terminal such as a smart phone or tablet PC, or a fixed terminal such as a desktop. For example, the user terminal U may include a mobile phone, a smartphone, a laptop computer, a digital broadcasting terminal, a personal digital assistant (PDA), a portable multimedia player (PMP), a slate PC, a tablet PC, an ultrabook, a wearable device (e.g., a smartwatch, a smart glass, a head mounted display (HMD)), etc.

The diagnostic device 200 may perform a security inspection on the target server, and perform a security tool inspection that performs an automatic inspection by using a security tool, simulated hacking, etc.

In general, in order to perform a security inspection through simulated hacking for a target server, a security officer with security inspection capabilities is required. However, since training and inspection of security officers requires a lot of time and effort, it is not easy to secure a large number of security officers, and accordingly, it is difficult to perform inspections of a large number of target servers on a periodic basis.

In addition, when performing a security inspection by using a security tool, it is possible to perform an inspection on a relatively large number of target servers, but if a vulnerability is identified, source modification is required to supplement the vulnerability. That is, the source modification is performed by the system manager, and there may be significant differences depending on the capabilities of each system manager. In addition, potential bugs and other errors may occur due to the source modification, but it is difficult to predict these in advance.

Meanwhile, the security inspection system 2000 according to an embodiment of the disclosure may perform simulated hacking specialized for each target server with minimal information by utilizing generative artificial intelligence, and may automatically generate and provide standardized correction codes even when inspecting by using the security tool. That is, since security inspections and vulnerability improvements may be performed without a security manager and a system manager for source code modification, thereby contributing to productivity improvement and reducing costs such as manpower. In addition, it is possible to minimize the time for identifying whether the existing functionality is normal after modifying the source code, identifying and modifying potential bugs in source code, and the cost for analysis.

Specifically, referring to FIG. 8, the diagnostic device 200 may include a security tool inspection unit 210 for performing a security tool inspection and simulated hacking unit 220 for performing simulated hacking.

The security tool inspection unit 210 may perform an automated security inspection on the target server by using a preconfigured security tool. That is, the security tool inspection unit 210 may identify the vulnerability of the target server by using the automated pipeline of the security tool, and if a vulnerability is found, the security tool inspection unit 210 may generate a correction code to supplement the vulnerability by using generative artificial intelligence. Specifically, a Gen AI code model generating a correction code for a vulnerability based on generative artificial intelligence may be trained in advance, and the correction code may be generated by using the Gen AI code model.

The simulated hacking unit 220 may build a retrieval-augmented generation (RAG) model for each target server, and automatically generate an inspection code for simulated hacking based on the data stored in the RAG model, thereby performing a security inspection on the target server. Here, since the RAG model built for each target server is utilized, it is possible to perform a security inspection without external leakage of confidential information, etc.

In addition, the diagnostic device 200 may perform regression tests on each security tool inspection unit 210 and the simulated hacking unit 220 to implement automatic improvements for performance of each unit. That is, the regression tests may be performed by using existing generated integrated test code and bug test code, and when the test fails, the test result may be stored in the history and then the diagnostic device 200 may request to regenerate the correction code for test success, including the bug-specific action code cases and change codes. This process may be repeated, and when the test succeeds, the successful cases may be updated, and the operator may be notified of the completion of the improvement.

Through this, even when a security manager or system manager is insufficient, it is possible to conduct a security inspection and generate a correction code that minimizes the impact on the target server when a vulnerability is found. That is, it is possible to strengthen the generation of correction codes for the code model based on generative artificial intelligence through test codes, failure history, and failure action codes by reinforcing the response through the regression testing. In addition, it is possible to perform simulated hacking an inspection using a security tool without information leakage through customization by domain, such as building an RAG model for each target server.

Therefore, finally, by applying the error-free correction code, which has all completed regression tests such as integrated tests and bug tests, to the target server and delivering the same to the operator, the operator may provide the completed result without a resource for separate inspection or source modification.

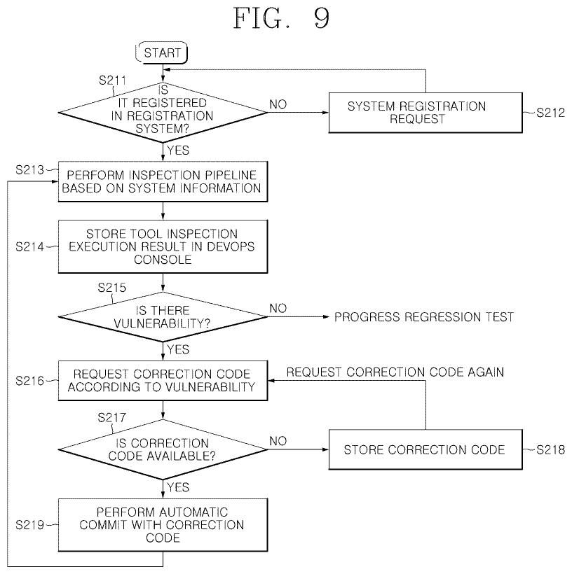

FIG. 9 is a flowchart illustrating a security tool inspection according to an embodiment of the disclosure.

Referring to FIG. 9, the operator may request a security tool-based inspection by inputting the desired inspection method, system information on the target server, etc. through the prompt of the generative artificial intelligence.

In this case, the security tool inspection unit 210 may first identify whether it is the target server registered for inspection (S211). That is, based on the information input in the prompt, the inspection method and system information may be distinguished according to the template, and the system information may be used to identify whether it corresponds to the pre-registered target server. Here, if it is not the registered target server, a registration request may be made to the operator to input the required system information (S212). On the other hand, if it is the registered target server, the pipeline information of the DevOps console for inspection may be obtained to prepare for inspection.

Thereafter, an inspection pipeline for security inspection may be performed based on the system information (S213), and a security tool-based inspection may be performed by using the provided URL information. In this case, the security tool used may be Sonarqube, Fortify, etc., but is not limited thereto. Here, the security tool may be configured for each target server.

When the inspection pipeline is completed, a tool inspection execution result may be stored in the DevOps console (S214). That is, when the inspection is completed, the tool inspection execution result may be stored, and depending on the embodiment, when storing the result, the existing source commit in GitHub and the vulnerability type may be mapped and stored. Here, the source without vulnerabilities may be used to provide additional guidance that there is no vulnerability when generating code with the corresponding pattern to the Gen AI code model. Meanwhile, in the case of the source with vulnerabilities, the source may be used to provide additional guidance that there is a vulnerability when generating code with the corresponding pattern to the Gen AI code model, and since there is a vulnerability, a correction code may be requested.

As the tool inspection execution result, it is possible to identify whether there is a vulnerability (S215), and if there is no vulnerability, a regression test may be performed. On the other hand, when a vulnerability exists, a correction code may be requested from the Gen AI code model (S216). That is, the operator may input a prompt to request the correction code, and when generating the prompt, a similarity measurement of the code that needs to be corrected may be performed, and additional guidance for vulnerability measures may be included in the prompt from the existing stored code information. In this case, the Gen AI code model may generate more accurate correction code. Depending on the embodiment, it is also possible to generate a correction code by including frameworks and 3rd party information extracted from the target server in the prompt. That is, the Gen AI code model may be requested to generate a correction code by generating a prompt using source code, additional guidance based on similarity measurement, system information, etc.

Thereafter, it is possible to identify whether the correction code received from the Gen AI code model is available (S217), and if it is determined that it is not available, the correction code corresponding to the failure case may be stored (S218), and the Gen AI code model may be requested to regenerate the correction code (S216). Here, the availability may be identified through a similarity measurement, and the failure case may be stored and used as an example when delivering the prompt so that the correction code with all vulnerabilities fixed may be generated. That is, a request may be made to generate a new correction code including the failure case stored in the prompt as an example.

Meanwhile, if it is determined to be usable (S217), the correction code may be automatically committed to GitHub (S218). That is, after the GitHub source is corrected and committed with the corresponding correction code, the inspection pipeline may be performed again (S213).

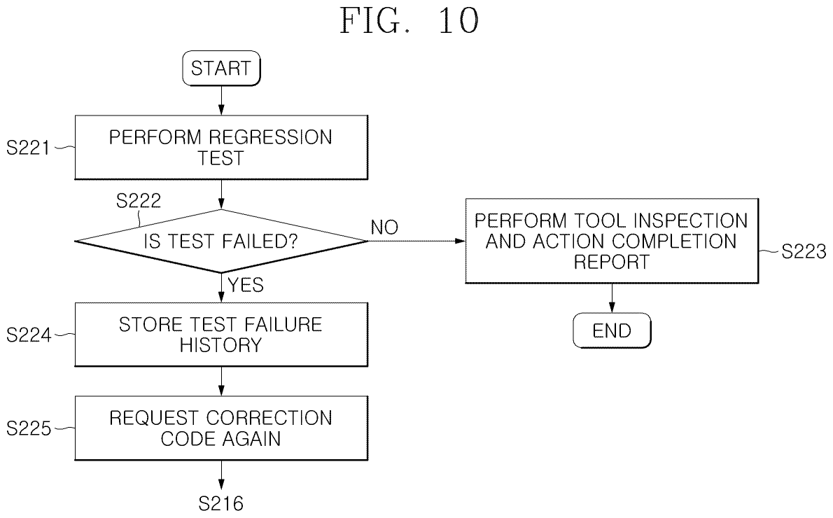

FIG. 10 is a flowchart illustrating a regression test according to an embodiment of the disclosure.

Referring to FIG. 10, when the security tool inspection is completed, a regression test may be performed on the target server (S221). Here, the regression test may be an integration test and a bug test. The regression test may be performed by calling the integration test and bug test code that were previously generated and tested. In this case, the test may be performed in parallel within a parallel performable range to minimize the test time.

Thereafter, it may be determined whether the regression test has failed (S222), and in this case, it may be determined whether the regression test has failed by comparing the normal response information previously stored for each test code with the response message from the target server.

Here, if the test is determined to be successful, the tool inspection and action completion report may be performed to the operator (S223). That is, since the vulnerability action on the target server is completed and the regression test result is not abnormal, the target server may be considered to have normally completed the security tool inspection action. Therefore, information on the discovered vulnerability and test results may be provided to the operator and the test may be terminated.

On the other hand, if the test is determined to be a failure, a procedure may be performed to eliminate the impact on the target server according to the correction code. That is, what error caused the test to fail may be stored in the test failure history (S224), and a prompt for regenerating the correction code may be generated (S225). Here, when generating the prompt, the failure history information may be used to identify the same cases that have occurred previously, and if there are identical cases, the corresponding correction code cases may be included as identical examples in the prompt. If there are no identical cases, similar cases may be searched for based on similarity measurement and included as similar examples in the prompt. If it is a newly occurring case, it may be included as an example for each case in the prompt.

Thereafter, returning to the correction code re-request step S216 of FIG. 9, a request may be made to the Gen AI code model to regenerate the correction code. When the correction code is regenerated, the regression test may be repeated through the same step.

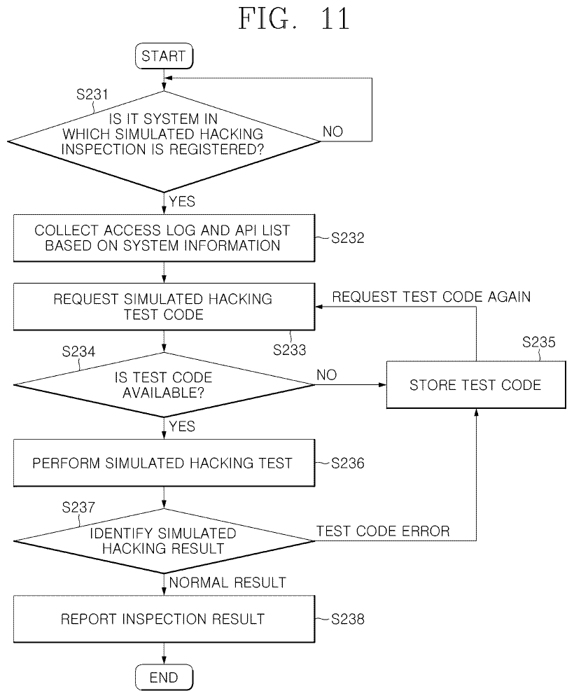

FIG. 11 is a flowchart illustrating simulated hacking according to an embodiment of the disclosure. Here, the operator may request simulated hacking by inputting the desired inspection method and system information on the target server through a prompt.

In this case, the simulated hacking unit 220 may first identify whether it corresponds to the target server registered for simulated hacking inspection (S231). That is, based on the information input in the prompt, the inspection method and system information may be separated according to the template, and the system information may be used to identify whether it corresponds to the target server registered for simulated hacking inspection. Here, if it is not the registered target server, a registration request may be made to the operator to input the required system information.

Thereafter, if the target server corresponds to the registered system, the simulated hacking unit 220 may collect the access log and API list based on the system information (S232). That is, access log information and API list information collected in the database in the target server may be collected.

In addition, information for simulated hacking may be generated from the collected access log information and API list information by using the RAG model generated by the target server's existing simulated hacking cases and vulnerability discovery cases. That is, it is possible to generate information such as URLs, headers, and bodies that may help generate test codes of the Gen AI code model.

Here, a prompt including the generated information as base information and simulated hacking test method such as XSS, intermediate page access, and SQL Injection may be generated.

Thereafter, the simulated hacking unit 220 may input a prompt to request simulated hacking test code from the Gen AI code model (S233), and identify whether the generated simulated hacking test code is available (S234). That is, if it is determined that there is a high possibility of failure when testing with the corresponding test code through similarity measurement, the corresponding test code may be requested to be regenerated. In this case, the failure case due to a simple code error or the like may be stored (S235) and used as an example when the prompt is delivered.

On the other hand, if it is determined to be available, simulated hacking test may be performed on the target server by using the simulated hacking test code (S236). Here, the simulated hacking result may be identified (S237), and in case of failure due to a simple code error, the test code may be stored and a request may be made to generate the test code again. On the other hand, if a normal result is shown, the inspection result may be reported to the operator (S238). That is, the results may be organized by each simulated hacking URL, API, and simulated hacking test method and reported to the operator.

Various embodiments of the present disclosure do not list all available combinations but are for describing a representative aspect of the present disclosure, and descriptions of various embodiments may be applied independently or may be applied through a combination of two or more.

As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method, the method comprising:
collecting diagnostic target data by searching for a target server according to a configuration pattern;
receiving, from a generative artificial intelligence server, additional diagnostic target data, the generative artificial intelligence server being configured to search the target server for the additional diagnostic target data to merge the additional diagnostic target data with the diagnostic target data;
generating a diagnostic script from the diagnostic target data according to an inspection policy;
performing an inspection on the target server with the diagnostic script to collect inspection data; and
generating a vulnerability analysis result for the target server by using the inspection data.

2. The method of claim 1, wherein the collecting of the diagnostic target data comprises:
searching for web pages included in the target server by using a hyperlink after logging in to the target server; and
collecting uniform resource identifiers (URIs) of the searched web pages and parameters corresponding to the URIs as the diagnostic target data.

3. The method of claim 2, wherein the merging of the diagnostic target data comprises:
receiving, from the generative artificial intelligence server, the additional diagnostic target data for a missing web page or parameter when searching for the target server.

4. The method of claim 3, wherein the merging of the diagnostic target data comprises:
receiving, from the generative artificial intelligence server, the additional diagnostic target data for the missing web page when a URI of the missing webpage and a prompt including a header area or body area responsive to a request message for the webpage being input to the generative artificial intelligence server.

5. The method of claim 4, wherein the generative artificial intelligence server is configured to extract each parameter corresponding to the URI according to a HTTP protocol-based POST method or a GET method used in the request message and to generate the additional diagnostic target data.

6. The method of claim 1, wherein the collecting of the inspection data comprises:
performing the inspection on the target server based one or more of passive inspection, active inspection, and singular inspection according to the inspection policy.

7. The method of claim 1, wherein the collecting of the inspection data comprises:
updating the inspection policy upon receiving an additional inspection policy for the target server from the generative artificial intelligence server.

8. The method of claim 7, wherein the collecting of the inspection data comprises:
receiving, from the generative artificial intelligence server, an additional inspection policy for performing an inspection on missing diagnostic target data or an attack pattern when inspecting the target server.

9. The method of claim 7, wherein the collecting of the inspection data comprises:
generating an additional diagnostic script from the diagnostic target data according to the updated inspection policy;
performing inspection on the target server with the additional diagnostic script to collect additional inspection data; and
merging the additional inspection data with the inspection data.

10. A non-transitory computer-readable storage medium storing instructions that, when executed by the one or more processors, configure the one or more processors to perform the method of claim 1.

11. An electronic device, comprising:
one or more processors configured to execute instructions; and
a memory storing the instructions, wherein execution of the instructions configures the processors to:
collect diagnostic target data by searching for a target server according to a configuration pattern;
receive, from a generative artificial intelligence server, additional diagnostic target data, the generative artificial intelligence server being configured to search the target server for the additional diagnostic target data, and merging the additional diagnostic target data with the diagnostic target data;
generate a diagnostic script from the diagnostic target data according to an inspection policy;
perform an inspection on the target server with the diagnostic script to collect inspection data; and
generate a vulnerability analysis result for the target server by using the inspection data.

12. The device of claim 11, wherein the collecting of the diagnostic target data comprises:
searching for web pages included in the target server by using a hyperlink after logging in to the target server; and collecting uniform resource identifiers (URIs) of the searched web pages and parameters corresponding to the URIs as the diagnostic target data.

13. The device of claim 12, wherein the merging of the diagnostic target data comprises:
receiving, from the generative artificial intelligence server, the additional diagnostic target data for a missing web page when searching for the target server according to the configuration pattern.

14. The device of claim 13, wherein the merging of the diagnostic target data comprises:
receiving, from the generative artificial intelligence server, the additional diagnostic target data for the missing web page when a URI of the missing webpage and a prompt including a header area or body area responsive to a request message for the webpage being received by the generative artificial intelligence server.

15. The device of claim 14, wherein the generative artificial intelligence server is configured to extract each parameter corresponding to the URI according to a HTTP protocol-based POST method or a GET method used in the request message to generate the additional diagnostic target data.

16. The device of claim 11, wherein the collecting of the inspection data comprises:
performing the inspection on the target server based on one or more of passive inspection, active inspection, and singular inspection according to the inspection policy.

17. The device of claim 11, wherein the collecting of the inspection data comprises:
updating the inspection policy upon receiving an additional inspection policy for the target server from the generative artificial intelligence server.

18. The device of claim 17, wherein the collecting of the inspection data comprises:
receiving, from the generative artificial intelligence server, an additional inspection policy for performing an inspection on missing diagnostic target data or an attack pattern when inspecting the target server.

19. The device of claim 17, wherein the collecting of the inspection data comprises:
generating an additional diagnostic script from the diagnostic target data according to the updated inspection policy;
performing inspection on the target server with the additional diagnostic script to collect additional inspection data; and
merging the additional inspection data with the inspection data.
